(19) United States
(12) Patent Application Publication
(10) Pub. No.: US 2009/0116878 A1
(43) Pub. Date: May 7, 2009

(54) COLOR SWITCHING ARCHITECTURE

(75) Inventor: Roger D. MASHAM, Herfordshire (GB)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 11/935,125

(22) Filed: Nov. 5, 2007

(51) Int. Cl. G03G 15/09

(52) U.S. Cl. 399/273

(57) ABSTRACT

A developer unit for a color imaging system includes a housing, a developer roll, and a magnetic stripping roll. The housing defines a chamber for holding developer material, which includes toner particles. The developer roll is mounted in the housing and rotates to attract developer material to flow on its surface. The developer roll carries the developer material into proximity to a latent image to create a toner image. The magnetic stripping roll is mounted in the housing and rotates between a functional and a non-functional position in proximity to the developer roll to strip developer material from the surface of the developer roll, cleaning the developer roll. The magnetic stripping rolls may include a magnet assembly with a functional position for activating the magnetic stripping roll and a non-functional position for deactivating the magnetic stripping roll. The magnetic stripping roll may be mounted to shift between two positions.

### BACKGROUND

This disclosure generally relates to color imaging systems, such as printers, copiers and other systems and specifically relates to a development process and system for use in color imaging systems.

Imaging is a process of creating an image on a sheet of media in an imaging system by using, for example, electrostatography or xerography (or electrophotography). Electrostatography is the recording of patterns (e.g., text to be printed on a piece of paper) by the production and use of latent electrostatic charge patterns. Xerography is a photocopying technique using dry ink and heat that is commonly used in office photocopiers and digital printers.

The imaging process typically involves the following steps: (1) charging, (2) exposure, (3) development, (4) transfer, (5) stripping, (6) fusing and (7) cleaning. In the charging step, an electrostatic charge is uniformly distributed over the surface of a photoreceptor, such as a rotating (or turning) drum (or belt) having a photoconductive surface. The electrostatic charge may be distributed by bias charging rolls, a corotron, a scorotron or other means. In the exposure step, the original document to be copied is illuminated and passed over a lens to project its image onto the drum. A light beam penetrates where there is text or image on the document and releases a charge pattern on the drum called a latent image. In the development step, the drum passes near developer material, which are attracted to the electrostatic latent image on the drum surface. This creates a toner image. In the transfer step, a piece of paper (or other media) is passed between the drum and a transfer corona. The toner image is transferred from the drum to the paper because the transfer corona applies a charge opposite to the charge on the surface of the drum. In the stripping step, electric charges on the paper are partially neutralized so that the paper can be stripped off from the drum. In the fusing step, the toner image is permanently fixed to the paper by, for example, using heat, pressure, or radiant fusing technology to melt and bond the developer material to the paper. Finally, in the cleaning step, the charge on the surface of the drum is discharged and any remaining toner that did not transfer in the transfer step is removed by, for example, a rotating brush or wiper.

In summary, in the imaging process to, for example, copy a desired image onto a piece of paper, a photoreceptor is charged and then selectively dissipated in accordance with a pattern of activating radiation corresponding to the desired image. The selective dissipation of the charge leaves a latent image on the surface of the photoreceptor that is developed by bringing developer material (e.g., toner) into contact with the latent image. This contact forms a toner image on the surface of the photoreceptor, which is transferred to the paper. The toner image on the paper is heated or fused to affix the toner image to the paper. Then, the surface of the drum is cleaned in preparation for making the next copy.

The development process may involve various kinds of developer materials. Two component and single component developer materials are commonly used in the development process. A typical two component developer material includes magnetic carrier and developer material. The developer material adheres triboelectrically to the carrier particles. A typical single component developer material includes developer material having an electrostatic charge so that the developer material is attracted to and adheres to the latent image on the photoreceptor surface. Single component development systems typically employ a developer roll to transport charged toner to the photoreceptor surface.

Developer materials may be brought in to contact with a latent image on a photoreceptor surface using various types (or architectures) of development systems. Some common types of development systems include scavengeless, magnetic roll and magnetic brush development systems.

Magnetic brush development systems use a magnetic developer roll. Developer material, which includes toner and carrier particles, is exposed to magnetic fields, causing the carrier particles to from brush-like strands, much in the manner of iron filings when exposed to a magnetic field. The developer material, in turn, is triboelectrically (i.e., using an electrical charge produced by friction) adhered to the carrier particles in the strands. What is thus formed is a brush of magnetic particles with developer material adhering to the strands of the brush. The base of the brush is formed on the magnetic developer roll, which is typically a sleeve rotating around a fixed arrangement of magnets. The toner and carrier particles form the brush on the outside of the sleeve and are influenced by the fields of the magnets inside the sleeve. This magnetic brush is brought into contact with the latent image on the photoreceptor surface and the developer material separate from the carrier particles and adhere to the photoreceptor surface to form the toner image.

Imaging systems for color imaging commonly include multi-pass and multi-stations engines. A pass occurs each time the photoreceptor having a latent image on its surface passes by the development system to create a toner image. In a multi-pass system, one color may be developed in one pass and then additional colors may be added in the subsequent passes. A multi-pass system may include four development stations, for example, one development station for developing each of four colors, cyan (C), magenta (M), yellow (Y), and black (K) (CMYK). The development process may be repeated in each of the passes to subsequently develop images of different colors in superimposed registration on a sheet of media (e.g., plain paper) to produce the full color image. In a multi-station engine system, one color may be developed during a single pass of the photoreceptor and additional colors may be developed in multiple registrations. A multi-station engine system includes one development station having multiple imaging stations in series. The multiple imaging stations in series develop multiple registrations of each of the colors to produce the full color image during a single pass.

However, such conventional color imaging systems may be costly to make and run and may require too much space. In some multi-pass systems, the development stations are cammed in and out to engage and disengage each of the development stations to produce the desired image one color at a time. Camming may cause unwanted vibrations that compromise image quality by, for example, creating blurred or misregistered color images or images with inappropriate color separation. In addition, the time spent camming increases the total time for producing the image.

### SUMMARY

It is therefore desirable to provide smaller development systems without camming at a reduced cost for color imagining systems.

Exemplary embodiments include a developer unit for a color imaging system including a housing, a developer roll, a supply auger, a mixing auger and a magnetic stripping roll. The housing defines a chamber for holding developer material, which includes toner particles. The developer roll is mounted in the housing and rotates to attract developer material to flow on its surface. The developer roll carries the developer material into proximity to a latent image to create a toner image. The magnetic stripping roll is mounted in the housing and rotates in proximity to the developer roll to strip developer material from the surface of the developer roll, cleaning the developer roll. The developer unit may also include a supply auger that may be mounted in the housing and may rotate in proximity to the developer roll to transport the developer material to supply the developer roll. The developer unit may also include a mixing auger that is mounted in the housing and rotates in proximity to the supply auger to mix fresh toner with the developer material and to transport developer material to the supply auger. The latent image may be retained on a photoreceptor. The magnetic stripping rolls may include a magnet assembly. The magnet assembly may include two semi-cylindrical partial cylinder magnets and an end cap at each end to hold the two magnets and form a complete cylinder defining magnetic poles. The magnetic stripping roll may be positioned at a functional position for activating the magnetic stripping roll and stripping developer material from the developer roll and a non-functional position for deactivating the magnetic stripping roll. The magnetic stripping roll may be mounted to shift between two positions.

Other exemplary embodiments include color imaging systems with multiple developer units for developing different colors, such as two developer units for developing two colors and four developer units for developing four colors.

### BRIEF DESCRIPTION OF THE DRAWINGS

FIG. 1 illustrates an imaging process in a xerographic printer in the related art;

FIG. 2 illustrates a development process and system in a copying machine in the related art;

FIG. 3 illustrates an exemplary embodiment of a two-pass magnetic brush development system;

FIG. 4 illustrates an elevational view of a magnetic roll in the related art;

FIG. 5 illustrates a sectional view of the magnetic roll taken along line 1-1 of FIG. 4;

FIG. 6 illustrates the magnetic roll of FIG. 4 assembled with a development sleeve to form a developer roll;

FIG. 7 illustrates a portion of a magnetic roll in the related art;

FIG. 8 illustrates the two-pass magnetic brush development system of FIG. 3 with two additional magnetic stripping rolls;

FIG. 9 illustrates various exemplary paths of the flow of developer material in the two-pass development system of FIG. 8; and

FIG. 10 illustrates an exemplary embodiment of a two-pass magnetic brush development process and system.

### EMBODIMENTS

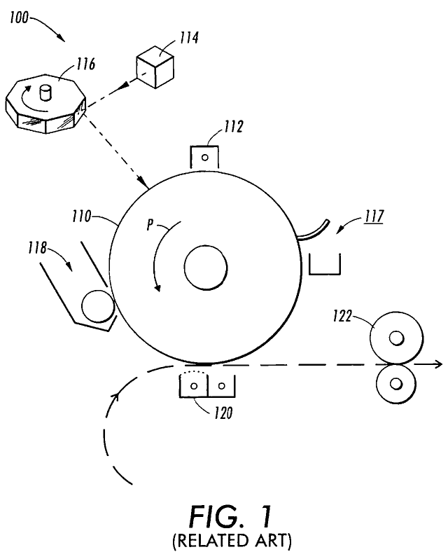

FIG. 1 illustrates an imaging process in a xerographic printer in the related art. As described in U.S. Pat. No. 6,876,829. FIG. 1 shows the basic elements 100 by which a xerographic printer (e.g. a copier or a laser printer) creates a dry-toner image on plain paper. There is provided in the printer a charge receptor such as photoreceptor 110, which may be in the form of a belt or drum, and which defines a charge-retentive surface for forming electrostatic images thereon. The photoreceptor 110 is caused to rotate through process direction P.

The first step in the imaging process is the general charging of the relevant photoreceptor surface. This initial charging is performed by a charge source 112, such as a scorotron. The scorotron 112 typically includes an ion-generating structure, such as a hot wire, to impart an electrostatic charge on the surface of the photoreceptor 110 moving past it. The charged portions of the photoreceptor 110 are then selectively discharged by a raster output scanner (ROS). The charged portions are selectively discharged in a configuration corresponding to the desired image to be printed. The raster output scanner generally comprises a laser source 114 and a rotatable mirror 116, which act together to discharge certain areas of the surface of the photoreceptor 110, according to the desired image to be printed. Although FIG. 1 shows a laser 114 to selectively discharge the charge-retentive surface, other apparatus may be used for this purpose, including a light-emitting diode (LED) bar, or, in a copier, a light-lens system. The laser source 114 is modulated (i.e., turned on and off) in accordance with digital image data fed into it. The rotating mirror 116 causes the modulated beam from the laser source 114 to move in a fast-scan direction perpendicular to the process direction P (e.g., clockwise) of the photoreceptor 110.

After certain areas of the photoreceptor 110 are discharged by the laser source 114, these areas are developed by a developer unit 118 causing a supply of dry toner to contact or otherwise approach the surface of the photoreceptor 110. The developed image is then advanced by the motion of the photoreceptor 110 to a transfer station 120. The transfer station 120 causes the toner adhering to the photoreceptor 110 to be electrically transferred to a print sheet, which is typically a sheet of plain paper, to form the image on the sheet of plain paper. The sheet of plain paper with the toner image is then passed through a fuser 122. The fuser 122 causes the toner to melt (or fuse) into the sheet of plain paper to create a permanent image.

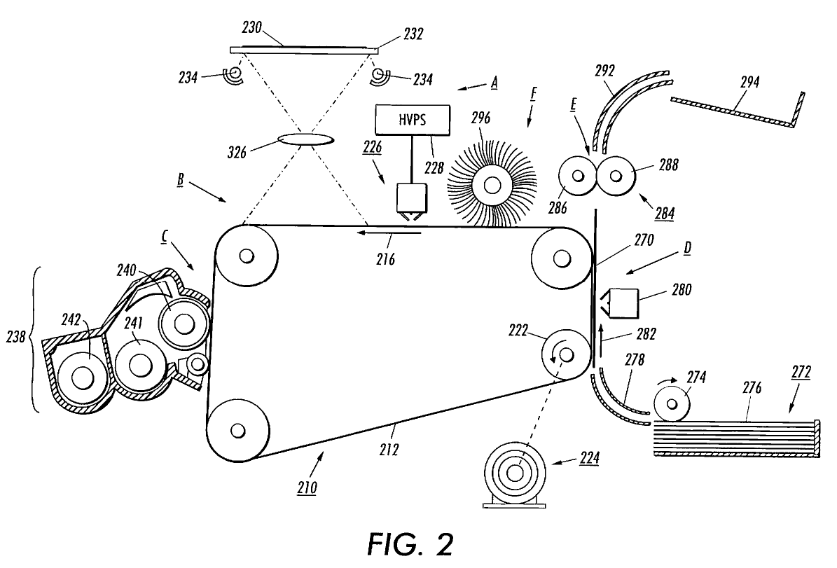

FIG. 2 illustrates an imaging process and system in a copying machine in the related art. A photoconductor 210 (e.g. a belt) with a photoconductive surface 212 moves in a direction 216 to advance successive portions of the photoconductive surface 212 sequentially through a number of processing stations along a path. A motor 224 rotates the photoconductor 210 in the direction 216 and a roller 222 is coupled to the motor 224 by suitable means, such as a drive belt. The processing stations along photoconductor 210 for the development process are: charging station A, exposure station B, development station C, transfer station D, fusing station E and cleaning station F.

Initially, a portion of the photoconductor 210 passes through charging station A. At charging station A, a corona generating device 226 charges the photoconductive surface 212 to a relatively high, substantially uniform potential. A high voltage power supply 228 is coupled to the corona generating device 226 to charge the photoconductive surface 212 of the photoconductor 210. After the photoconductive surface 212 of the photoconductor 210 is charged, the charged portion is advanced through an exposure station B.

At exposure station B, an original document 230 is placed face down upon a transparent platen 232. Lamps 234 flash light rays onto the original document 230. The light rays reflected from the original document 230 are transmitted through a lens 236 to form a light image. The lens 236 focuses this light image onto the charged portion of the photoconductive surface 212 to selectively dissipate the charge. This records an electrostatic latent image on the photoconductive surface 212 that corresponds to the informational areas contained within the original document 230.

After the latent image has been recorded on the photoconductive surface 212, the photoconductor 210 advances the latent image to development station C. At development station C, a developer unit 238 develops the latent image recorded on the photoconductive surface 212. The developer unit 238 includes a developer roll 240, a supply auger 241 and a mixing auger 242. The developer roll 240 is electrically biased relative to the photoconductive surface 212. The latent image attracts toner particles from the developer material 243, forming a toner powder image. Developer roll 240, supply auger 241, and mixing auger 242 are mounted, at least partially, in the chamber of the developer housing. The chamber in the developer housing stores a supply of developer material.

After the latent image is developed, the photoconductor 210 advances the toner powder image to transfer station D. A copy sheet 270 is advanced to transfer station D by a sheet feeding apparatus 272. The sheet feeding apparatus 272 includes a feed roll 274 contacting the uppermost sheet of stack 276 into chute 278. Chute 278 directs the advancing sheet of support material into contact with the photoconductive surface 212 of the photoconductor 210 in a timed sequence so that the toner powder image developed contacts the advancing sheet at transfer station D. Transfer station D includes a corona generating device 280 that sprays ions onto the back side of sheet 270. The sprayed ions attract the toner powder image from the photoconductive surface 212 to the sheet 270. After transfer, the sheet 270 continues to move in a direction 282 onto a conveyor (not shown) that advances the sheet 270 to fusing station E.

Fusing station E includes a fuser assembly 284 that permanently affixes the transferred powder image to the sheet 270. Fuser assembly 284 includes a heated fuser roller 286 and a backup roller 288. The sheet 270 passes between the fuser roller 286 and the backup roller 288 with the toner powder image contacting the fuser roller 286. In this manner, the toner powder image is permanently affixed to the sheet 270. After fusing, the sheet 280 advances through a chute 292 to a catch tray 294 for subsequent removal from the copying machine by an operator.

After the sheet 280 is separated from the photoconductive surface 212 of the photoconductor 210, the residual toner particles adhering to the photoconductive surface 212 are removed at cleaning station F. Cleaning station F includes a rotatably mounted fibrous brush 296. Before cleaning, a discharge lamp (not shown) floods the photoconductive surface 212 with light to dissipate any residual electrostatic charge remaining prior to the charging of the photoconductive surface 212 for the next successive imaging cycle. This completes the description of the general operation of the development process of the copying machine shown in FIG. 2.

While FIG. 2 illustrates a development system for producing black and white images, typically, multi-pass or single-pass systems are used for producing color images. Single pass systems include four imaging stations to overlay the four different colors to produce a full color image. Multi-pass systems may include two-pass and four-pass systems. In a four-pass color imaging system, there may be one imaging station including four developer units (similar to the developer unit 238 shown in FIG. 2) that may be cammed in and out to overlay the four different colors in the development process to produce a full color image. In a two-pass color imaging system, there may be two imaging stations each having two developer units that may be cammed in and out to overlay the four different colors in the development process to produce a full color image. Mechanically camming developer units in and out may cause blurred or misregistered images. Exemplary embodiments of the present invention include two-pass, four-pass and other multi-pass development systems that avoid the problems associated with camming. In place of such mechanical camming mechanisms, exemplary embodiments employ magnetics to affect the flow of developer material.

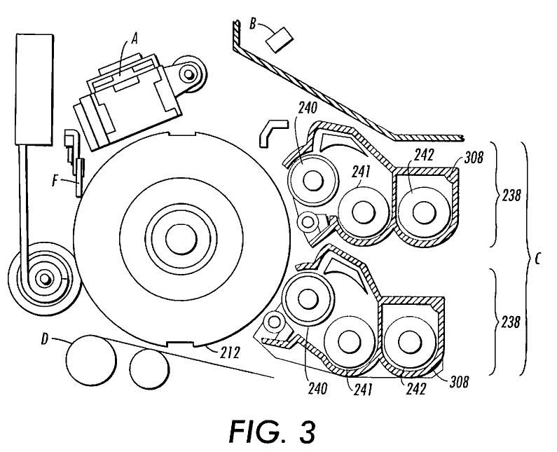

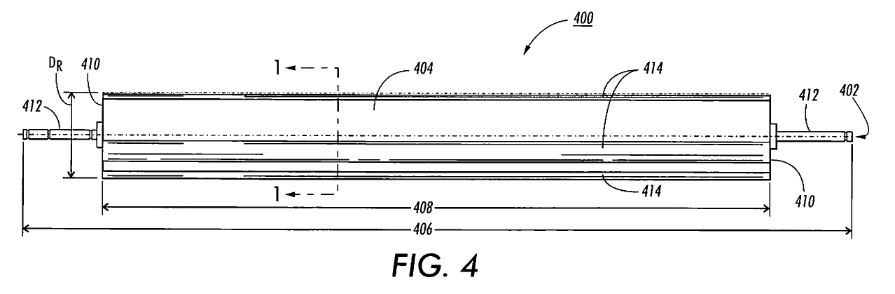

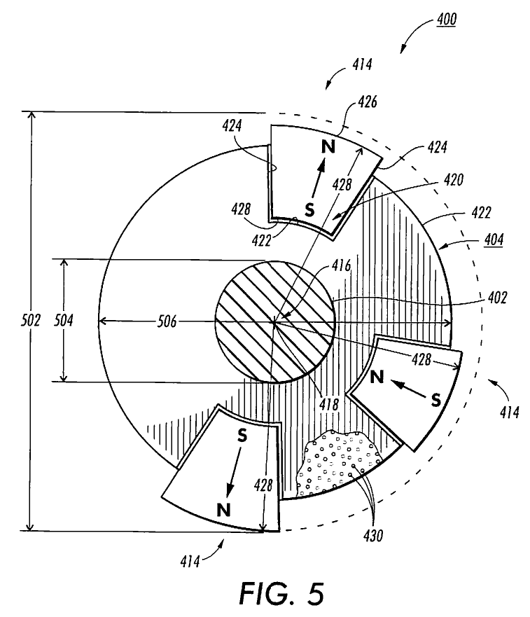

FIG. 3 illustrates an exemplary embodiment of a two-pass magnetic brush development system. Each of the two developer units 238 includes a developer roll 240, a supply auger 241 and a mixing auger 242. Each developer unit 238 is within a housing 308. Housing 308 defines a chamber that holds developer material. The developer roll 240, the supply auger 241 and the mixing auger 242 may be disposed in the housing 308. The developer roll 240 rotates in proximity to the developer material so that some of the developer material is attracted to the developer roll 240 and flows on its surface. The developer roll 240 rotates in proximity to both the supply auger 241 and the photoreceptor 112. The supply auger 241 transports developer material to supply the developer roll 240. The developer roll 240 transports developer material to the photoreceptor interface, where toner is electrostatically attracted to the latent image. The mixing auger 242 mixes fresh toner with the developer material and transports developer material to the supply auger 241. Rotating members 240, 241, 242 may be mounted on spindles and may rotate in various directions.
The magnetic brush development system of FIG. 3 uses magnetics to affect the flow of developer material around the roll 242 in the developer units 238. This development process is performed in the exemplary two-pass system of FIG. 3 for two colors, in which one color is developed in each of the two passes. Each of the two developer units 238 develops a different color. The two developer units 238 are each activated and deactivated on an alternating basis to allow each color to be developed during one of the two passes. The activation and deactivation is preferably accomplished magnetically by adding a magnetic roll, (e.g., a magnetic roll of FIG. 4, 5, 6, or 7) to each of the two developer units 238 of FIG. 3 to get the development system of FIG. 5

Development is typically accomplished by the use of a magnetic brush. The magnetic brush is typically formed by a developer roll, which is typically in the form of a cylindrical sleeve that rotates around a fixed assembly of permanent magnets. In magnetic brush development, the cylindrical sleeve is typically made of an electrically conductive, non-magnetic conductive material, for example, aluminum.

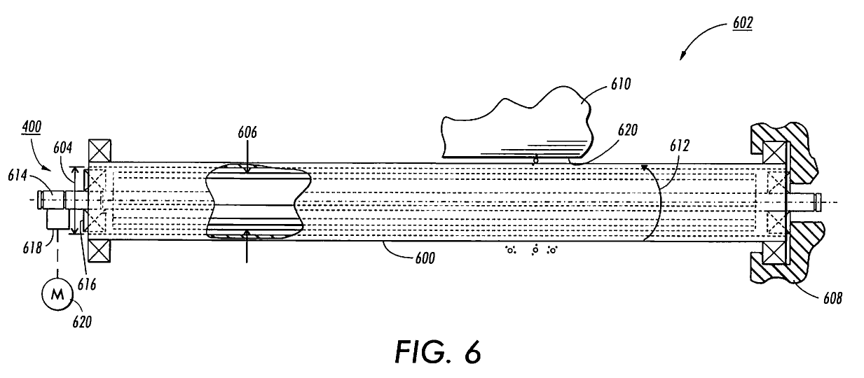

FIG. 4 illustrates an elevational view of a magnetic roll 400 in the related art. FIGS. 4-6 are disclosed in U.S. Pat. No. 6,125,255, which is hereby incorporated by reference in its entirety. The magnetic roll 400 is typically included in an assembly (see FIG. 6) and includes a shaft 402 about which a core 404 is positioned. The shaft 402 serves to position the magnetic roll 400 and as such the shaft 402 has a length 406 larger than length 408 of the core 404. Extending outwardly from the ends 410 of the core 404 are journals 412. Around the periphery of the core 404 are magnets 414, which are shown in more detail in FIG. 5.

FIG. 5 illustrates a sectional view of the magnetic roll 400 taken along line 1-1 of FIG. 4. The magnetic roll 400 includes the shaft 402 and the core 404, which is positioned about the shaft 402.

The shaft 402 may be made of any suitable durable material capable of supporting the core 404. For example, the shaft 402 may be made of a metal, such as cold rolled steel SAE 1020. While the shaft 402 may have any shape, the shaft 402 typically has a cylindrical shape with radius 502 and diameter 504. The diameter 504 is of sufficient size to support the magnetic roll 400.

The core 404 is positioned about the shaft 402 and preferably molded onto the shaft 402. The core 404 has a sleeve centerline 416 that is coincident with centerline 418 of the shaft 402. The core 404 preferably has pockets 420 for properly positioning magnets 414 about the periphery 422 of the core 404. Preferably, the magnetic roll 400 includes a number of magnets 414. For example, as shown in FIG. 5, the magnetic roll 400 includes three magnets 414. The relative angular positions and the radii of the periphery of the magnets 414 are preferably chosen to obtain the desired magnetic fields to best transfer the developer material from the developer housing to the photoreceptor.

The pockets 420 may have any suitable shape, but preferably include a bottom 422 and side walls 424 extending radially outward from the bottom 422. The pockets 420 are so positioned and sized such that the outer periphery 426 of the magnets 414 define a radius 428 from the centerline 418 of the shaft 402. To effect different magnetic strengths at each of the magnets 414, the radii 428 may be different.

The magnets 414 may be made of any suitable durable material that is permanently magnetizable. For example, the magnets 414 may be made of a ferrous metal or a plastic material including magnetizable materials dispersed therein. While the magnets 414 may have any suitable shape, typically the magnets 414 have a uniform cross-section, as shown in FIG. 5, which extends in a direction parallel to the centerline 418 of the shaft 402. The magnets 414 may be magnetized with any suitable polarity. For example, as shown in FIG. 5, the periphery 426 of the magnets 414 may be defined as a north pole (N), while the bottom 428 of the magnet 414 may be defined as a south pole (S). The other two magnets 414 may have similar or opposite polarity.

The core 404 may be made of any suitable durable moldable or castable material. For example, the core material may be a polyester, a nylon, an acrylic, a urethane or an epoxy, or any castable resin that is castable at low pressures. This core material may be fortified with fillers, for example, milled glass, glass fibers, conductive fillers, or reinforcements. In addition, the core material may include microballoons 430. The microballoons 430 may have a generally spherical shape and a diameter of approximately 20 to 130 microns, with approximately 60 microns being preferred. A cellular structure may be created by dispersing a gas within the molding material during the molding process to manufacture the core 404 or a chemical blowing agent may be added that decomposes during the molding process to a gas that provides the cellular structure.

Referring now to FIG. 6, the magnetic roll 400 is shown assembled within a sleeve or tube 600 to form the developer roll 602. The tube 600 may be made of any suitable durable non-ferromagnetic materials, for example, aluminum or plastic. The tube 600 has an inner diameter 604, which is slightly larger than the diameter 606 of the magnetic roll 400. The tube 600 and the magnetic roll 400 serve to form the developer roll 602, which is typically an assembly. The developer roll 602 may operate by either a stationary tube 600 having a rotating magnetic roll 400 located therein or by having a rotating tube 600 rotating about a fixed magnetic roll 400. The tube 600 and the magnetic roll 400 may ultimately both rotate in either the same or opposite directions.

As shown in FIG. 6, the tube 600 is rotatably secured to a developer housing 608 and is driven by a power source (not shown) in an appropriate direction to advance developer material from the developer housing 608 to the photoreceptor 610. The magnetic roll 400 rotates in the direction of arrow 612 and is supported at shaft 614 by bearings 616. The bearings 616 are mounted in the inner periphery of the tube 600. The magnetic roll 400 is rotated by a drive mechanism 618, which is driven by a suitable power source, for example, a motor 620. The magnets 414 of the magnetic roll 400 thus advance the developer material around the periphery of the tube 600 in the direction of arrow 612 towards the surface 622 of the photoreceptor 610.

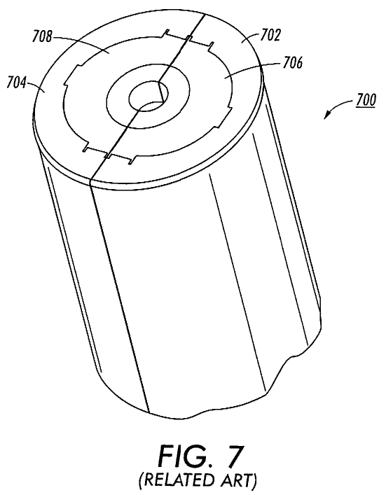

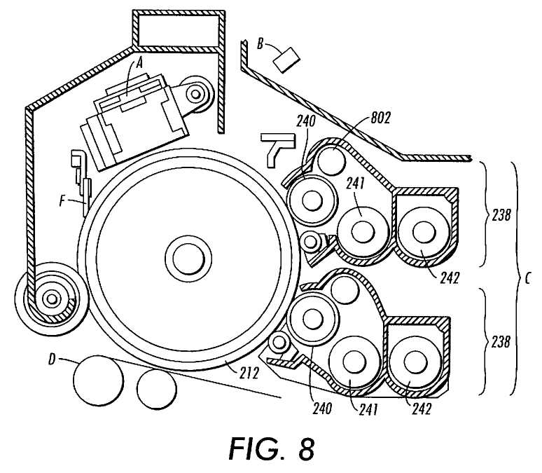

FIG. 7 illustrates a portion of a known magnetic roll 700 such as the one disclosed in U.S. Pat. No. 6,422,984, the disclosure of which is hereby incorporated herein in its entirety. The magnetic poles of multiple magnetic rolls 700 may be arranged to facilitate the development process for the development system of FIG. 8. The magnetic roll 700 has a magnet assembly that may be formed from two semi-cylindrical partial cylinders 702, 704. The partial cylinder magnets 702, 704 may be molded and attached to each other to form a complete cylinder defining magnetic poles along the circumference of the magnetic roll 700. Each end of the magnetic roll 700 may be formed by complementary semi-circular end caps 706, 708. Small projections from each end cap 706, 708 may correspond to a concave surface of either partial cylinder magnet 702, 704, allowing the end caps 706, 708 to be secured within the magnetic roll 700. The two partial cylinder magnets 702, 704 may be attached by adhesive at their interfaces or attached only at the interface between end caps 706, 708. The magnetic roll 700 may be flow formed or extruded aluminum or aluminum alloy tubes surrounding fixed multi-pole rubber magnets. Typically, magnetic rolls are strip, molded, or ceramic in construction. The partial cylinder magnets may be held in position by flats on respective spindles about which the magnetic roll 700 rotates by means of bearings in the end caps 706, 708.

FIG. 8 illustrates the two-pass magnetic brush development system of FIG. 3 with two additional magnetic stripping rolls 802. Each developer unit 238 has a magnetic stripping roll 802 in addition to the developer roll 240, supply auger 241, and mixing auger 242. The developer roll 240, supply auger 241, and mixing auger 242 of each developer unit 238 is used for development of a particular color. Once that particular color is developed, the magnetic stripping roll 802 is tripped and developer material is diverted around an alternative path, which removes the material from contact with the photoconductive surface 212. Once the developer roll 240 is clear, the developer unit 238 for that color is shut down (i.e., no longer driven). Then, the magnetic stripping roll 802 of the other developer unit 238 is rotated to turn on (i.e., drive) the developer unit 238 for the next color.

The magnetic stripping rolls 802 or their magnet assemblies may be rotated into two or more positions to alter the path of the flow of developer material. Each magnetic stripping roll 802 is positioned in close proximity to the developer roll 240 in order to affect the flow of developer material with magnetic forces. The magnetic stripping roll 802 is activated (or actuated) to divert the flow of developer material from the developer roll 240. The magnetic stripping roll 802 may be deactivated to permit the flow of developer material onto the developer roll 240. Deactivation of the magnetic stripping roll 802 can be achieved by rotating the magnet assembly internal to the magnetic stripping roll 802 into a non-functional position. The magnetic stripping roll 802 may be activated by rotating the internal magnet assembly into a functional position. Stripping may include not only diverting the flow of developer material from the developer roll 240 but also carrying the flow around the magnetic stripping roll to a sump (not shown). Once the developer roll 240 is stripped, the internal magnet assembly may be rotated to the non-functional position. Thus, the flow of the developer material is directed magnetically by the arrangements and/or positions of the magnetic poles in the magnetic assemblies of the magnetic stripping rolls 802 for development of each color of the toner image on the photoreceptor 212.

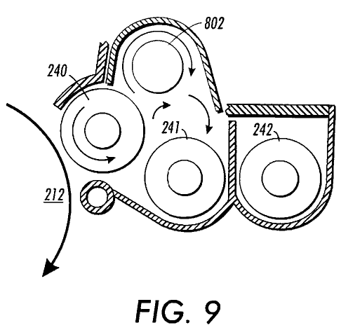

FIG. 9 illustrates various exemplary flow paths of developer material around and between the two rolls of one of the developer units 238 of the two-pass development system of FIG. 8. The magnetic stripping roll 802 may be rotated clockwise such that the surface of the magnetic stripping roll 802 moves in the same direction as the developer roll 240 and developer material is diverted back to the supply auger 241, leaving the developer roll 240 clean. In this way, the flow of developer material may be switched magnetically from counterclockwise to clockwise (or vice-versa) to switch developer material on and off the developer roll 240 without having to reverse the rotational direction of the developer roll 240. An appropriate electrical bias may also be applied between the magnetic stripping roll 802 and the developer roll 240 between passes, just before shut down of the machine or at other times, leaving the developer roll 240 surface clean of toner particles. This is advantageous because a clean developer roll 240 delivers minimal contamination to the photoconductive surface 212 and no interaction with previously developed images thereon.

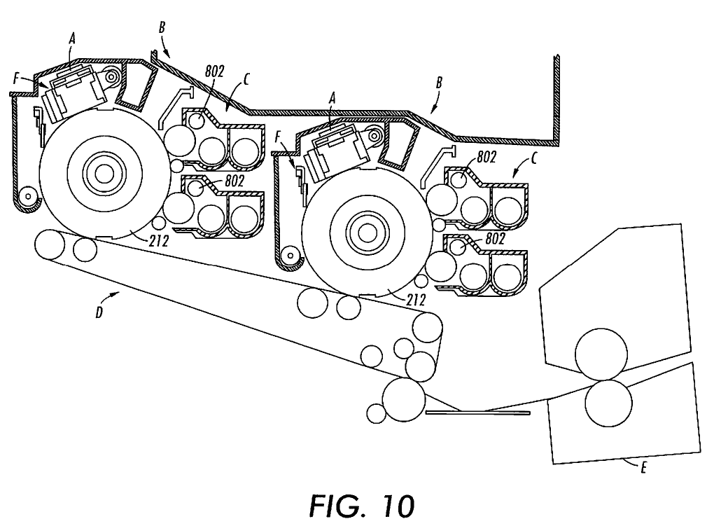

FIG. 10 illustrates an exemplary embodiment of a two-pass magnetic brush development process and system. This two-pass development system includes two photoreceptors 212 that rotates in a clockwise direction past each processing station in the image formation process. The processing stations along photoreceptor 212 are: charging station A, exposure station B, development station C, transfer station D, fusing station E and cleaning station F.

At charging station A, the surface of the photoreceptor 212 is charged by a charge source, such as a scorotron. A scorotron typically includes an ion generating structure, such as a hot wire, that imparts an electrostatic charge on the surface of the photoreceptor 212 as it moves past the scorotron.

At the exposure station B, the charged portions of the photoreceptor 212 are then selectively discharged in a configuration corresponding to the desired image to be printed, by a raster output scanner (ROS), which may include laser source and a rotatable mirror that act together to discharge certain areas of the surface of the photoreceptor 212 according to the desired image to be printed. In place of a laser, other apparatus may be used to selectively discharge the charge retentive surface of the photoreceptor 212, such as a light emitting diode (LED) bar, or, in a copier, a light-lens system. In the case of a laser source, the laser source is modulated (i.e., turned on and off) in accordance with digital image data fed into the laser source and the rotating mirror causes the modulated beam from the laser source to move in a fast-scan direction perpendicular to the process direction (e.g. clockwise) of the photoreceptor 212.

At the development station C, after certain areas of the photoreceptor 212 are discharged by the laser source of the ROS, these areas are developed by the developer units 238, causing a supply of developer materials (e.g., dry toner) to contact or otherwise approach the surface of the photoreceptor 212. Each developer unit 238 includes two rolls, including a magnetic stripping roll 802.

At transfer station D, the toner adhering to the photoreceptor 212 is electrostatically transferred to a sheet of media (typically a sheet of plain paper) to form the toner image on the sheet. The sheet with the toner image on it is then passed through a fuser, which causes the toner to melt or fuse onto the sheet to create the permanent image at the fusing station E. At cleaning station F, the photoreceptor 212 is cleaned to ready the photoreceptor 212 for repeating the development process at charging station A.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A developer unit for a color imaging system, comprising:
a housing defining a chamber for holding developer material;
a photoreceptor having a surface for retaining a latent image;
a developer roll mounted in the housing and rotatable to attract the developer material to the surface of the developer roll and to carry the developer material into proximity to the latent image to create a toner image; and
a magnetic stripping roll mounted in the housing and rotatable in proximity to the developer roll to strip developer material from the surface of the developer roll.

2. The developer unit of claim 1, further comprising:
a rotatable supply auger mounted in the housing and in contact with the developer material to supply the developer material to the surface of the developer roll.

3. The developer unit of claim 2, further comprising:
a rotatable mixing auger mounted in the housing and in contact with the developer material to mix fresh toner with the developer material and transport the fresh toner and the developer material to the rotatable supply auger.

4. The developer unit of claim 1, wherein the magnetic stripping roll includes a magnet assembly comprising:
a core;
a plurality of magnets positioned about the core; and
a sleeve rotatable around the core.

5. The developer unit of claim 1, wherein the magnetic stripping roll includes a magnet assembly having:
at least one partially cylindrical magnet; and
a first and second end, an end cap at each end of the magnetic stripping roll to hold the at least one partially cylindrical magnet to form a complete assembly of magnetic poles.

6. The developer unit of claim 1, wherein the magnetic stripping roll is positionable at a functional position for activating the magnetic stripping roll and stripping developer material from the developer roll, and at a non-functional position for deactivating the magnetic stripping roll.

7. The developer unit of claim 1, wherein the magnetic stripping roll is mounted to shift between two positions.

8. A color imaging system comprising:
the developer unit according to claim 1 for developing a first color; and
a second developer unit for developing a second color.

9. The color imaging system of claim 8, further comprising:
a first photoreceptor, the first photoreceptor being in contact with both the developer unit and the second developer unit, the magnetic stripping roll being selectively activated to switch between the developer unit and the second developer unit by allowing developer material from only one of the developer unit and the second developer unit at a time to deliver developer material to the first photoreceptor.

10. The color imaging system of claim 9, further comprising:
a second photoreceptor; and
a third developer unit and a fourth developer unit in contact with the second photoreceptor, the third and fourth developer units for developing a third and fourth color, respectively.

11. A method of development for a color imaging system, comprising:
housing developer material in a chamber;
rotating a developer roll in the chamber to attract the developer material to a surface of the developer roll;
carrying the developer material into proximity to a latent image on a photoreceptor to create a toner image;
rotating a magnetic stripping roll in the chamber in proximity to the developer roll; and
selectively stripping developer material from the surface of the developer roll.

12. The method of claim 11, further comprising:
rotating a supply auger in the chamber to supply the developer material to a surface of the developer roll.

13. The method of claim 12, further comprising:
rotating a mixing auger in the chamber to mix fresh toner with the developer material.

14. The method of claim 13, further comprising:
transporting the mixed fresh toner and the developer material to the supply auger.

15. The method of claim 11, wherein the magnetic stripping roll includes a magnet assembly, the magnet assembly having a core, a plurality of magnets positioned about the core, and a sleeve rotatable around the core.

16. The method of claim 11, wherein the magnetic stripping roll has a first end and a second end, and an end cap disposed at each of the first and second ends, the magnetic stripping roll further having a magnetic assembly including at least one partially cylindrical magnet.

17. The method of claim 16, further comprising:
holding the at least one partially cylindrical magnet with the end cap to form a complete assembly of magnetic poles.

18. The method of claim 11, further comprising:
activating the magnetic stripping roll to strip developer material from the developer roll at a functional position;
deactivating the magnetic stripping roll at a non-functional position; and
mounting the magnetic stripping roll to shift between two positions.

19. The method of claim 11, further comprising:
developing a first color with a first developer unit;
developing a second color with a second developer unit; and
contacting a first photoreceptor with both the first and second developer units.

20. The method of claim 19, further comprising:
providing a second photoreceptor;
contacting a third and fourth developer unit with the second photoreceptor;
developing a third and fourth color with the third and fourth developer units, respectively; and
selectively activating the magnetic stripping roll to switch between the development units by allowing developer material from only one of the first and second developer units at a time to deliver developer material to the first photoreceptor.
